(19) United States
(12) Patent Application Publication
(10) Pub. No.: US 2002/0038302 A1
(43) Pub. Date: Mar. 28, 2002

(54) Questionnaire server and method for generating and distributing questionnaires

(75) Inventor: Atsushi Maeda, Osaka (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/823,244

(22) Filed: Mar. 30, 2001

(30) Foreign Application Priority Data
Sep. 26, 2000 (JP) JPA 2000-291510

(51) Int. Cl. G06F 17/30; G06F 17/60

(52) U.S. Cl. 707/100; 707/104.1; 705/52

(57) ABSTRACT

A questionnaire server for a questionnaire requester to customize a questionnaire based on a form is presented. The requester selects desired questions in a predefined form. In addition, the requester can specify a target selection criterion to determine target users for the questionnaire and a closing condition to terminate the questionnaire. Then the requester can check the estimate of the questionnaire fee based on the specified conditions. Furthermore, the requester can award points to the target users according to the questions answered. Therefore, the user incentive for responding to the questionnaire can be enhanced resulting in a high response ratio.

### BACKGROUND OF THE INVENTION

1. Field of the Invention

The present invention relates to questionnaire generation and distribution technology, and it particularly relates to a questionnaire server and method which generate a questionnaire based on a form, propose a questionnaire fee, and distribute the questionnaire to specified target users.

2. Description of the Related Art

Since Internet service providers and application service providers have users as their regular members, they are in a good position to conduct questionnaire investigations on a large scale. Such network service providers are potentially highly efficient as a vehicle for product marketing or opinion polling.

However, network providers have difficulties in meeting the requirements of their customers who request market investigations or opinion polls, since they have little know-how of marketing and opinion polling techniques. It is hard for them to know what kind of questionnaire is appropriate for the particular purposes of their customers. They might also encounter financial problems in the method of recovering the costs of the questionnaire and in charging fees to their customers, and a management problem in how to provide their users with an incentive for responding to the questionnaire. Therefore, it is difficult for them to conduct a questionnaire investigation effectively.

### SUMMARY OF THE INVENTION

It is therefore an object of the present invention to provide a questionnaire server and method to enable a questionnaire requester to customize a questionnaire based on a provided form and enable a service provider to charge an appropriate fee to the requester. It is also an object of the present invention to provide an effective technique to obtain a response to the questionnaire from a target user and to recover the cost of the questionnaire.

According to one aspect of the present invention, a questionnaire server is provided. The server includes a questionnaire database, an inputting unit, and a charge calculation unit. The questionnaire database stores a questionnaire form with a plurality of question items. The inputting unit receives from a requester of a questionnaire, questions generated based on the form, a target selection criterion to choose target users for the questionnaire, and a closing condition to terminate the questionnaire. The charge calculation unit calculates a questionnaire fee based on the number of the questions, a question style, the target selection criterion, and the closing condition. The charge calculation unit recalculates the questionnaire fee and presents the fee to the requester, whenever at least any one of the questions, the target selection criterion, and the closing condition is changed.

The server may be connected to a computer of the questionnaire requester and a computer of the target user. In this case, the questionnaire may be created on a Web page, and the distribution and collection of the questionnaire may be via a transaction using Web pages or e-mail. The server may be configured in such a manner that the questionnaire is created, distributed and collected by fax, phone, post, or other communication means.

The server may further include a user database which stores user's personal information including the user's attribute data and point data, a target selection unit which chooses target users who correspond to the target selection criterion, based on the user information stored in said user database; and a point setting unit which determines the number of points to be awarded to the target users, based on the number and the style of the questions. The charge calculating unit calculates the questionnaire fee based on said number of points. The closing condition may be a desired number of the target users, the fee ceiling, an upper limit for times and duration of displaying an advertisement announcing the questionnaire, an upper limit of the number of e-mail messages to distribute or announce the questionnaire, or the period within which the response to the questionnaire is to be made.

The questionnaire database may store an actual response ratio corresponding to at least one of the number and the style of the questions and the target selection criterion. The charge calculating unit may predict an expected response ratio for the questionnaire specified by the requester by using said actual response ratio, and present the fee with the expected response ratio to the requester. The target selection unit may determine the number of the target users that the questionnaire is distributed to by using said actual response ratio.

The form may include the question items in an alternative answer style and a free answer style. The points may be set for each question item and the number of the points may be greater for the question item in the free answer style than in the alternative answer style. In this case, the user incentive for responding to the questions in the free answer style can be greatly enhanced.

The inputting unit may receive a question item entered by the requester, and the questionnaire database may store said question item entered by the requester as a part of the form.

The server may further include an aggregating unit which aggregates responses to the questionnaire and updates the point data of the target user who responds the questionnaire, according to the number of the points defined for the question answered. Since the respondents to the questionnaire may not always answer all the questions, it may be more preferable to award to users the points only for the questions answered.

According to another aspect of the present invention, a questionnaire method is provided. The method includes providing a questionnaire form with a plurality of question items to a requester of a questionnaire, receiving questions generated based on the form, a target selection criterion to choose target users for the questionnaire, and a closing condition to terminate the questionnaire, and presenting to the requester a questionnaire fee recalculated whenever at least one of the questions, the target selection criterion, and the closing condition is changed.

The method may further include distributing the questionnaire to target users chosen on the basis of the target selection criterion, collecting the responses to the questionnaire from the target users, and awarding a predefined number of points to a target user who responds to the questionnaire according to the number of the questions and a question style.

Moreover, any arbitrary combination of the above-mentioned structural components in the present invention is still effective as an embodiment when applied as a method, a system, and a computer program, and so forth.

This summary of the invention does not necessarily describe all necessary features so that the invention may also be a sub-combination of these described features.

### BRIEF DESCRIPTION OF THE DRAWINGS

FIG. 1 shows a block diagram of a questionnaire system according to an embodiment of the present invention.

FIG. 2 illustrate an example of a questionnaire form displayed on a requester PC.

FIG. 3a shows a question form in an alternative answer style.

FIG. 3b shows a question form in a free answer style.

FIG. 4 shows an example of a form for inputting target selection criteria.

FIG. 5 shows an example of a form for entering closing conditions.

FIG. 6 shows an example of an estimate of a questionnaire fee.

FIG. 7 shows a table that contains a different number of points for each question style.

FIG. 8 shows an example of an actual response ratio.

FIG. 9 is a flowchart showing a questionnaire procedure.

### DETAILED DESCRIPTION OF THE INVENTION

The invention will now be described on the basis of the preferred embodiments, which do not intend to limit the scope of the present invention, but exemplify the invention. All of the features and the combinations thereof described in the embodiment are not necessarily essential to the invention.

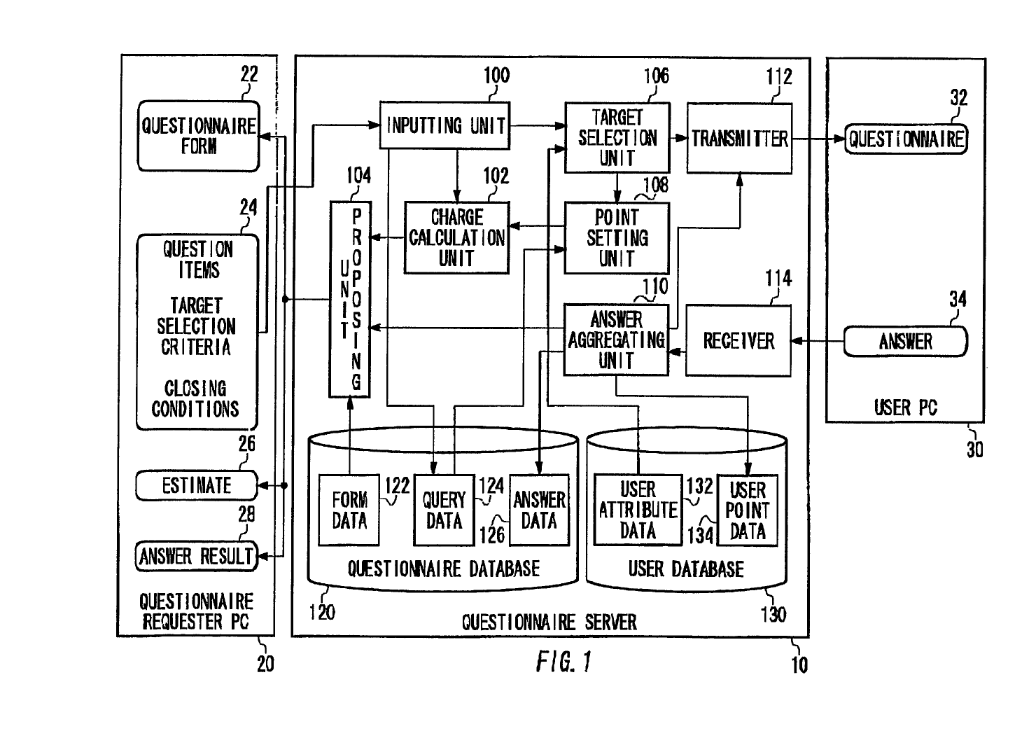

FIG. 1 shows a block diagram of a questionnaire system according to an embodiment of the present invention. The questionnaire system includes a questionnaire server 10, a questionnaire requester PC 20, and a user PC 30. The questionnaire requester PC 20 and the user PC 30 connect to the questionnaire server 10 via networks, which is not shown in the figure. The questionnaire requester PC 20 and the user PC 30 function as a personal computer. The questionnaire server 10 functions as a normal computer having a database. Therefore the structure of the questionnaire server 10 may be implemented with a CPU, memory and a program loaded in the memory. In the figure, however, the blocks are not divided in terms of hardware and/or software component, but in terms of function. The skilled in the art can therefore understand that the various combinations of hardware and software components can achieve the function of these blocks.

The questionnaire server 10 includes an inputting unit 100, a charge calculation unit 102, a proposing unit 104, a target selection unit 106, a point setting unit 108, an answer aggregating unit 110, a transmitter 112, and a receiver 114. The questionnaire server 10 includes a database interface which is not shown, and accesses to a questionnaire database 120 and a user database 130 to retrieve, store and update data.

The questionnaire database 120 stores questionnaire form data 122, question data 124, and answer data 126. The form data 122 is a collection of questions and alternative answers. The questionnaire forms may be categorized according to business types of the customers, topics or themes. A proposing unit 104 retrieves the form data 122 stored in the questionnaire database 120, and provides the questionnaire requester PC 20 with a questionnaire form for displaying. The questionnaire form may be selected according to the business type of the questionnaire requester or the questionnaire theme. The questionnaire requester PC 20 displays the questionnaire form 22 and enables the requester to select and specify the question and answer items.

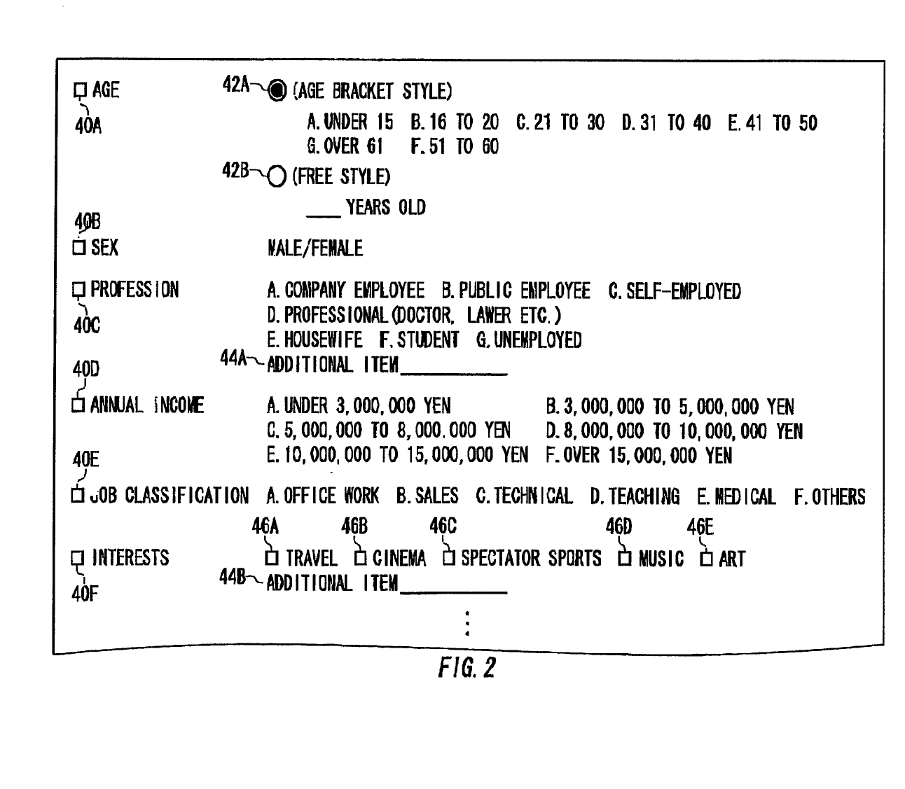

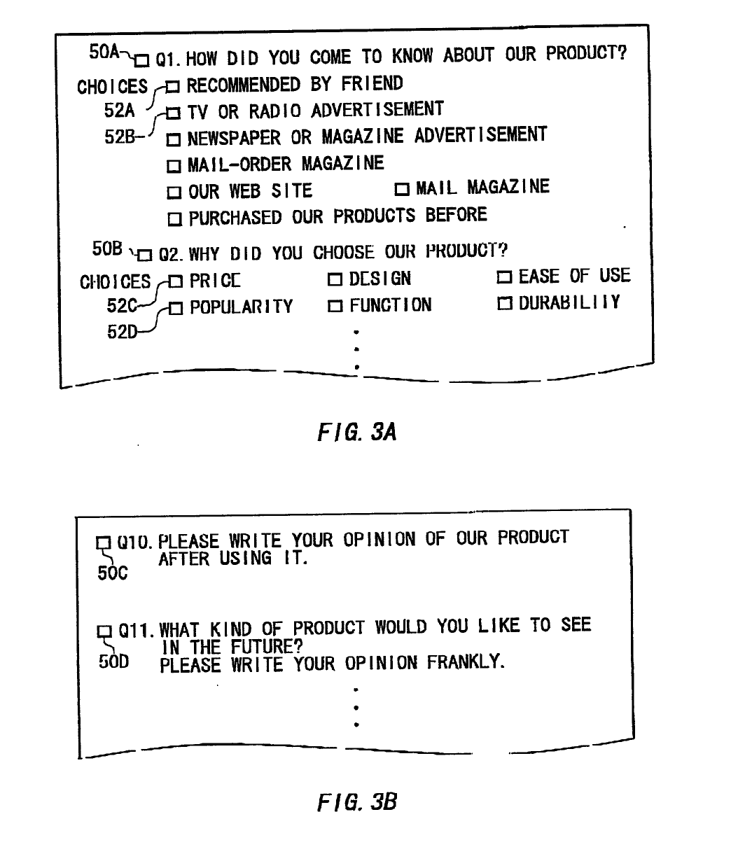

FIG. 2 and FIGS. 3a and 3b illustrate an example of the questionnaire form 22 displayed on the requester PC 20. FIG. 2 illustrates an example of questions relating to the attributes of a respondent, and the alternative answers to the questions. By selecting any of the check buttons 40A to 40F, the corresponding questions are chosen. For instance, in the case of the answer forms for the question of asking the respondent's age, there are one answer form for replying by age bracket and another form for entering the age in years. The desired form can be selected by activating either button 42A or 42B. There is also a provision for asking the respondent's profession with alternative answers, and further user-specified alternatives can be added by filling additional items in a field 44A. In addition, alternative answers with check buttons 46A to 46E are displayed for the question of asking the respondent's interests, and any desired alternatives can be selected for use by selecting the appropriate check buttons. Thus, requesters can freely customize the questionnaire by specifying the question items, the answer style, and the alternative answers.

FIG. 3a shows a question form in an alternative answer style. The desired questions can be chosen by selecting any of the check buttons 50A and 50B. Alternative answers can also be chosen for use by selecting the check buttons 52A to 52D. A new alternative answer may be added. FIG. 3b shows a question form in a free answer style. The questionnaire requester may add a new question in the free style besides the questions already on the form. A pre-defined question on the forms may be modified to create a new question.

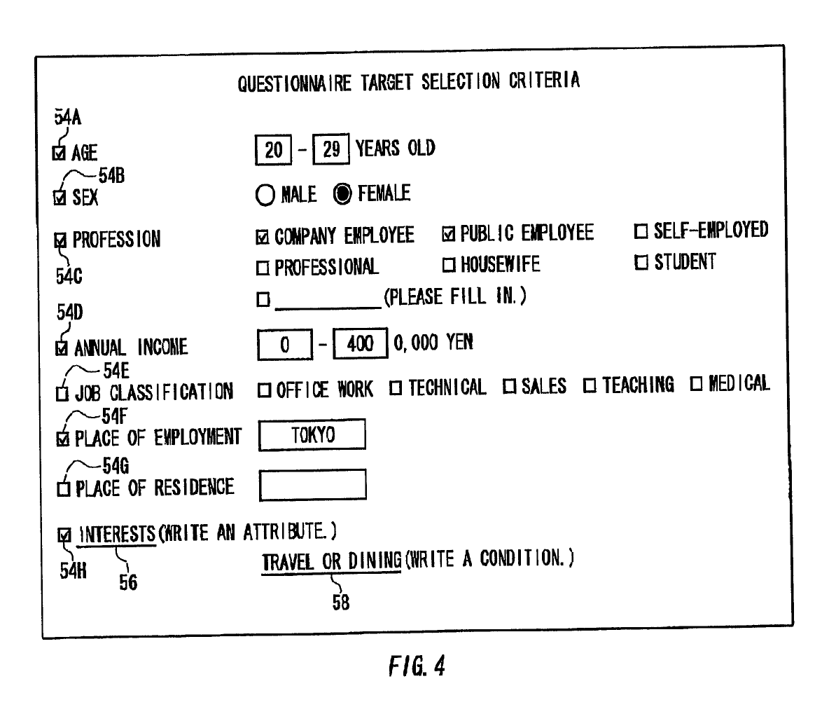

Referring back to FIG. 1, the proposing unit 104 provides the requester PC 20 with a form for inputting criteria to choose a questionnaire target. FIG. 4 shows an example of the form for inputting the criteria displayed on the requester PC 20. The requester selects the attribute items by activating any of the check buttons 54A to 54H and specifies criteria for the selected attribute items. In this example, since the check buttons 54E and 54G are not marked, the corresponding attribute items will not be considered. The requester may select the check button 54H, and fill in an attribute item 56 and a criterion 58 as a new attribute criterion. The criteria specified by the requester will be used to determine the actual questionnaire target users.

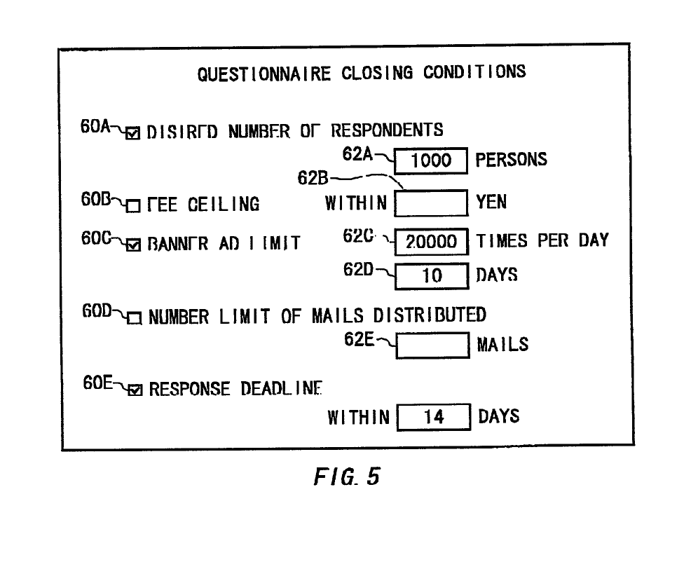

Furthermore, the proposing unit 104 provides the requester PC 20 with a form for inputting the closing conditions of the questionnaire such as the number of respondents or a fee ceiling. FIG. 5 shows an example of the forms for entering the closing conditions displayed on the requester PC 20. Examples of the closing conditions are, for instance, the desired number of respondents, the upper limit of charges, banner advertisement limitations, the maximum number of mails to be distributed, and the response deadline.

As shown in the figure, the desired number of respondents is set to 1000, and the distribution and collection of the questionnaire is closed when the number of respondents reaches 1000. The banner advertisement limitation specifies a banner advertisement display period 62D and the number of a banner advertisements to be displayed per day 62C, when the questionnaire is announced in the banner advertisement on Web pages, and users can click the banner advertisement and respond to the questionnaire displayed on the Web pages. The number limit of mails distributed specifies the number of mails to be distributed when the questionnaire is distributed in the form of direct mails or mail magazines. The response deadline specifies the period within which the response is to be made. When the response deadline is specified, the distribution and collection process is terminated at the deadline and the collected answers are aggregated to evaluate the results. If both the desired number of respondents and the response deadline are specified, the distribution and the collection process is terminated when either of these conditions is met.

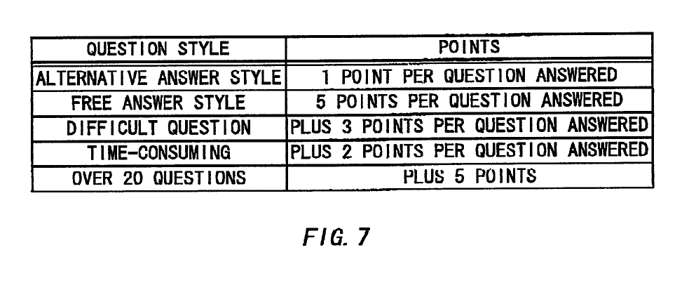

Referring to FIG. 1 again, the question items and the target selection criteria, and the closing conditions are entered into the inputting unit 100 via networks, and stored as question data 124 in the questionnaire database 120. The target selection unit 106 selects a target that corresponds to the specified target selection criteria by referring to the user attribute data 132 stored in the user database 130. The user attribute data 132 is the personal information that includes the user attributes such as age, sex, address, profession, and annual income. The point setting unit 108 sets the number of points to be awarded to the target users who respond to the questionnaire. A different number of points may be set for each question item. FIG. 7 shows a table that contains a different number of points for each of the question styles. In the case of an alternative answer style and a free answer style, one point and five points are awarded respectively. For a difficult question, three points are added per question. Further points can be added when the question requires some amount of time for answering, for instance when research or investigation is necessary, or when the number of questions exceeds 20. Thus, the number of points may vary according to the style and kind of the questions.

Referring to FIG. 1, the charge calculation unit 102 calculates the fee to be charged to the questionnaire requester. The questionnaire fee may vary according to the question configuration in which the number of question items and the question style differ. The fee may differ according to the specified target selection criteria that determine the target bracket or the number of target users. For instance, for a specific user bracket such as elderly businessmen, the response ratio may be relatively low or the number of target users small. As a result, as it is relatively difficult to obtain responses to the questionnaire, it costs more to implement the questionnaire, resulting in a higher fee. The fee may differ according to the points to be awarded to the target users. When the target users have more incentive for answering the questionnaire, for example when more points are awarded, a higher fee might be charged to the questionnaire requesters to compensate for the points awarded.

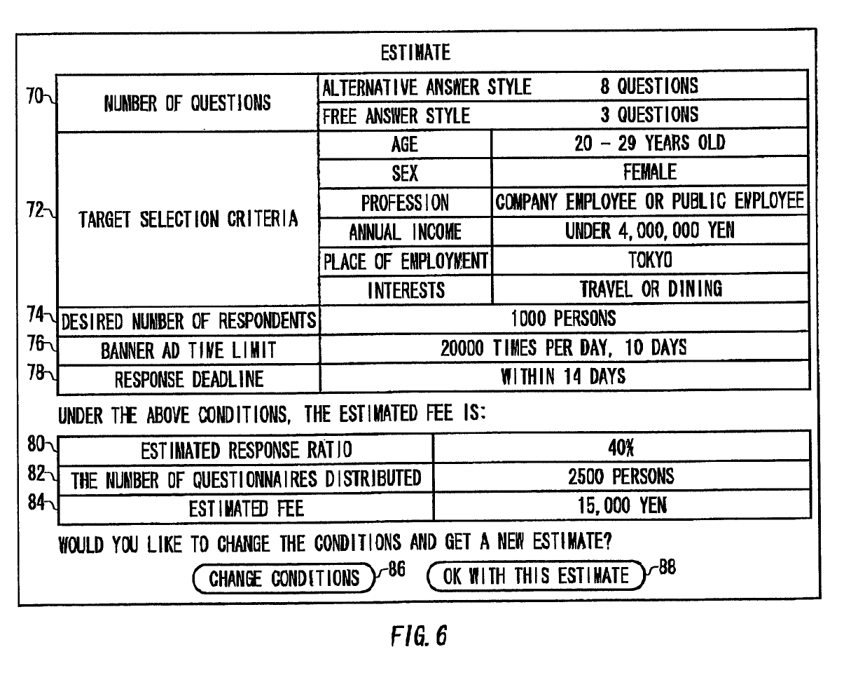

The proposing unit 104 provides the requester PC 20 with an estimate on the basis of the fees calculated by the charge calculation unit 102. FIG. 6 shows an example of the estimate displayed on the requester PC 20. The number of questions 70, the target selection criteria 72, the desired number of respondents 74, the banner advertisement time limit 76, and the response deadline 78 are displayed. Also, an expected response ratio 80, the number of questionnaires to be distributed 82, and the estimated fee 84 are displayed. If the estimate is not satisfactory, the requester can change the number of questions or the answer style, and modify the target selection criteria or the closing conditions by clicking a condition change button 86. Then the requester can request a new estimate of the fee. If the estimate is now satisfactory, the requester clicks an OK button 88 and requests the distribution and collection of the specified questionnaire.

Referring to FIG. 1, the transmitter 112 sends the questionnaire 32 to the user PC 30 for which the questionnaire is targeted by the target selection 106. The receiver 114 receives an answer 34 from the user PC 30. The answer aggregating unit 104 stores the answer 34 as answer data 126 in the questionnaire database 120, and sends a signal to the transmitter 112 when the closing conditions are met, so that the transmitter 112 can restrict the distribution of the questionnaire and the answers 34 collected from then on may be stored in a temporary area or discarded. There may be several different methods of distributing the questionnaire, such as an announcement in a Web banner advertisement, a questionnaire in an e-mail, an announcement in a mail magazine and so on. The transmitter 112 may provide the user with the questions displayed on the Web or in the e-mail message. The receiver 114 may obtain the answers from the Web server or in the form of an e-mail reply.

The answer aggregating unit 110 updates the user point data 134 stored in the user database 130 for the target users who respond to the questionnaire. Target users do not always answer all the questions in the questionnaire, so the number of points awarded corresponds to the number of question items replied to. The number of points may vary depending on the number of written characters or the contents of the reply in the case of the free answer style questions.

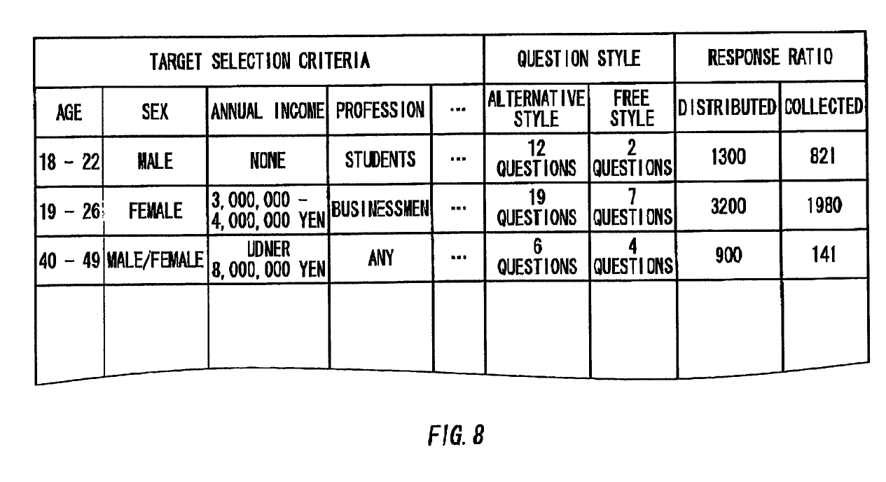

The answer aggregating unit 110 outputs an answer result 28 which is the aggregate of the answer data 126 from the target users, and the proposing unit 104 provides the requester PC 20 with the answer result 28. Furthermore, by aggregating the answer data 126, the answer aggregating unit 110 calculates the actual response ratio and figures out statistically how different the response ratio is depending on the number of the questions, the kind and style of the questions, the target selection criteria, and the number of points to be awarded. FIG. 8 shows an example of an actual response ratio. The number of the collected responses against the number of the distributed questionnaires is categorized by the target selection criteria, the number and style of the questions. The ratio of the two numbers gives the actual response ratio. The above-mentioned estimated response ratio for the specified target selection conditions may be calculated by using this actual response ratio.

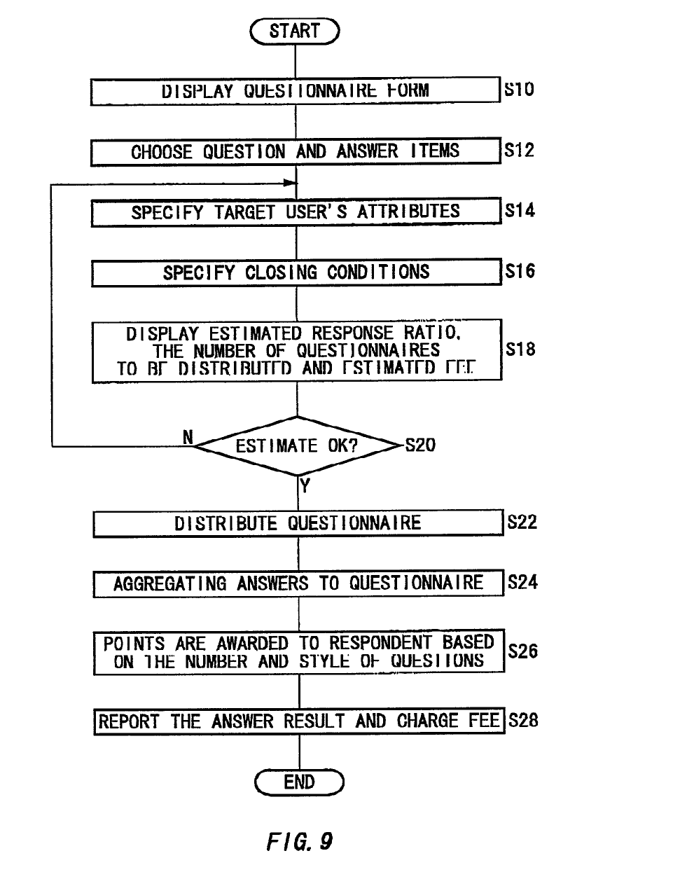

FIG. 9 shows a process flow realized with the above configuration. The questionnaire form is displayed on the requester PC (S10). The requester chooses the question items and the answer items (S12). The personal attributes and the selection criteria of the attributes are specified to target a specific user bracket, and the target selection criteria is provided (S14). The closing condition of the questionnaire is specified (S16). The estimated response ratio, the number of questionnaires to be distributed, and the estimate of the fee are calculated and displayed on the basis of the specified target selection criteria, the number and style of the questions, and the closing conditions (S18). If the estimate is not satisfactory (N of S20), the process goes back to S14, otherwise goes on to S22. The questionnaire is replicated and distributed to the target users based on the target selection criteria and the closing conditions (S22). The answers to the questionnaire are collected and aggregated (S24). The points are calculated for the questions answered and awarded to the target users (S26). The answer results and the statistics are forwarded to the requester of the questionnaire and the questionnaire fee is charged to the requester (S28).

As described above, in accordance with the questionnaire system of this embodiment, the questionnaire requester can customize the questionnaire by selecting the question items by using and modifying the predefined questionnaire form. Moreover, the requester can specify the questionnaire target selection criteria and the closing conditions of the questionnaire, and then check the estimate of the questionnaire fee. The requester checks the updated estimate of the fee whenever he/she changes the number of the questions, the target selection criteria and the closing conditions. Furthermore, the requester of the questionnaire or the service provider can award different numbers of points to the target users who respond to the questionnaire depending on the number and style of the questions. Therefore, the user incentive for responding to the questionnaire can be greatly enhanced and the response ratio can be improved. The service provider can obtain the questionnaire form that is newly created by the requester and utilize the new form for other requesters.

Although the present invention has been described by way of exemplary embodiments, it should be understood that many changes and substitutions may be made by those skilled in the art without departing from the spirit and the scope of the present invention. Some such alterations are now explained.

The above-mentioned questionnaire system may be applied to a service where an application service provider distributes the questionnaire to its members and awards points, in exchange for a communication fee or service fee. In this kind of service, the questionnaire requester may offer the points or gifts to the target respondents.

What is claimed is:

1. A questionnaire server comprising:
a questionnaire database which stores a questionnaire form with a plurality of question items;
an inputting unit which receives from a requester of a questionnaire, questions generated based on the form, a target selection criterion to choose target users for the questionnaire, and a closing condition to terminate the questionnaire; and
a charge calculation unit which calculates a questionnaire fee based on the number of the questions, a question style, the target selection criterion, and the closing condition,
wherein said charge calculation unit calculates the questionnaire fee and presents the fee to the requester, whenever at least any one of the questions, the target selection criterion, and the closing condition is changed.

2. The server of claim 1, further comprising:
a user database which stores user's personal information including the user's attribute data and point data;
a target selection unit which chooses target users who correspond to the target selection criterion, based on the user information stored in said user database; and
a point setting unit which determines the number of points to be awarded to the target users, based on the number and the style of the questions.

3. The server of claim 2, wherein said charge calculating unit calculates the questionnaire fee based on said number of points.

4. The server of claim 1, wherein:
said questionnaire database stores an actual response ratio corresponding to at least one of the number and the style of the questions and the target selection criterion; and
said charge calculating unit predicts an expected response ratio for the questionnaire specified by the requester by using said actual response ratio, and presents the fee with the expected response ratio to the requester.

5. The server of claim 1, wherein:
said questionnaire database stores an actual response ratio corresponding to at least one of the number and the style of the questions and the target selection criterion; and
said target selection unit determines the number of the target users that the questionnaire is distributed to by using said actual response ratio.

6. The server of claim 2, wherein the form includes the question items in an alternative answer style and a free answer style, and the points are set for each question item and the number of the points are greater for the question item in the free answer style than in the alternative answer style.

7. The server of claim 1, wherein the inputting unit receives a question item entered by the requester, and the questionnaire database stores said question item entered by the requester as a part of the form.

8. The server of claim 5, further comprising an aggregating unit which aggregates responses to the questionnaire and updates the point data of the target user who responds the questionnaire, according to the number of the points defined for the question answered.

9. A questionnaire method comprising:
providing a questionnaire form with a plurality of question items to a requester of a questionnaire;
receiving questions generated based on the form, a target selection criterion to choose target users for the questionnaire, and a closing condition to terminate the questionnaire; and
presenting to the requester a questionnaire fee recalculated whenever at least one of the questions, the target selection criterion, and the closing condition is changed.

10. The method of claim 9, further comprising:
distributing the questionnaire to target users chosen on the basis of the target selection criterion;
collecting the responses to the questionnaire from the target users; and
awarding a predefined number of points to a target user who responds to the questionnaire according to the number of the questions and a question style.

11. The method of claim 9, further comprising aggregating an actual response ratio corresponding to at least one of the number and the style of the questions and the target selection criterion, and an expected response ratio predicted based on the actual response ratio is presented with the questionnaire fee.

12. The method of claim 11, further comprising determining the number of the target users whom the questionnaire is distributed by using said actual response ratio, and the questionnaire is distributed to the determined number of the target users.

13. The method of claim 10, wherein the form includes the question items in an alternative answer style and a free answer style, and the points are set for each question item and the number of points are greater for the question item in the free answer style than in the alternative answer style.

14. The method of claim 9, wherein a question item entered by the requester is utilized as a part of the questionnaire form.

15. The method of claim 13, wherein the points are awarded to the target user who responds to the questionnaire, according to the number of the points defined for the question answered.
